(19) United States
(12) Patent Application Publication
(10) Pub. No.: US 2016/0140098 A1
(43) Pub. Date: May 19, 2016

(54) METHODS AND APPARATUS FOR ELECTRONICALLY AUTHENTICATING DOCUMENTS

(71) Applicant: iPegs Ltd., Chester (GB)

(72) Inventor: Adam LEESE, Warrington (GB)

(21) Appl. No.: 14/884,318

(22) Filed: Oct. 15, 2015

Related U.S. Application Data
(60) Provisional application No. 62/064,296, filed on Oct. 15, 2014.

(51) Int. Cl. G06F 17/24; G06F 3/00; G06F 3/0488

(52) U.S. Cl. CPC G06F 17/242; G06F 3/0488; G06F 3/005

(57) ABSTRACT

A method for electronically signing a document by a user by using an electronic device, is disclosed. The method includes displaying the document on a user interface of the electronic device, wherein the user interface includes control fields for receiving user inputs. The method further includes capturing the user inputs upon selection of the control fields by the user. The method further includes processing the user inputs to generate outputs, wherein the processing is performed based on predefined parameters associated with each of the user inputs. The method further includes generating a document signature by using at least one of the outputs, wherein the document signature is a unique one time signature identifying the user. The method further includes electronically embedding the document signature in the electronic document.

### CROSS-REFERENCE TO RELATED APPLICATIONS

This application claims the benefit of U.S. Provisional Application Ser. No. 62/064,296 filed Oct. 15, 2014, entitled “Face Stamp” which is incorporated herein by reference.

### BACKGROUND

The disclosed subject matter relates to methods and apparatus for authenticating documents. More particularly, the disclosed subject matter relates to digital security systems, and methods for authenticating electronic documents.

Industrial and commercial work generally includes organized processes that require printed documents for communication, contracts, and agreements. In fact, a primary medium of communication such as inter-office communication or intra-office communication was through papers. For example, reports were typed manually on papers and were signed by authorized personnel. Therefore, global consumption of paper is rising day by day. However, usage of papers can result in various disadvantages, for instance misspellings of words in a printed document cannot be automatically detected and corrected, the whole document needs to be printed again after correction, handling of large number of papers is a cumbersome task and also difficult to transport, cost inefficient, etc. The use of paper is reduced by the advent of embraced technology such as electronic documents.

### SUMMARY

The usage of paper arises various issues such as, a user has to input data manually in documents, most of the time, paperwork is incomplete, documents can be lost or damaged due to mishandling, fraudulent signatures, etc. These issues can be overcome by using electronic documents. The use of electronic documents provide a number of advantages over prior art such as, reducing usage of paper and its transportation cost, return on investment (ROI) by reducing transaction time, increasing security by reducing fraudulent signatures, reducing error rates, However, authenticity of the electronic documents is one of a major concerns.

Handwritten signature on a paper can be authenticated by using prior art techniques; however, the same techniques cannot be used for authenticating the electronic documents.

Some related art uses electronic signature or digital signature to authenticate the electronic documents. The electronic signature can be defined as an legally recognized way for individuals to approve content of an electronic document. In other words, the electronic signature can provide evidence that a commitment has been explicitly endorsed between two parties under a signature policy, at a given date and time. However, the electronic signatures on the electronic documents also need to be authenticated.

Some related art uses Public Key Infrastructure (PKI) technology for the security of the electronic signature. The PKI technology binds unique public keys with user identities to confirm the identity of the user. This technology encodes the electronic document with a private key and transmits the electronic document to a recipient. The recipient uses a public key to verify authenticity of the electronic document. In some other related arts, digital certificates are used to authenticate the electronic documents. However, such techniques can be useful in cases where the electronic document needs to be e-mailed to a recipient who is going to sign the electronic document at a different location. In addition, this technology cannot be used when a recipient of the electronic document is present at a same location, such as face-to-face, of a sender of the electronic document, as emailing the electronic document to the recipient becomes an unnecessary and cumbersome task.

It may therefore be beneficial to provide a digital security system, and methods of authenticating electronic document, that address at least one of the above issues. For example, it may be beneficial to provide a digital security system for authenticating electronic documents.

It may therefore be beneficial to provide methods and apparatus that address at least one of the above and/or other disadvantages. In particular, it may be beneficial to provide digital security systems, as well as methods of authenticating electronic documents, to enhance security of the electronic documents.

Some embodiments are therefore directed to electronically sign a document by a user by using an electronic device. The method includes displaying the document on a user interface of the electronic device, wherein the user interface includes one or more control fields for receiving one or more user inputs; capturing the one or more user inputs upon selection of the one or more control fields by the user; processing the one or more user inputs to generate one or more outputs, wherein the processing is performed based on one or more predefined parameters associated with each of the one or more user inputs; generating a document signature by using at least one of the one or more outputs, wherein the document signature is a unique one time signature identifying the user; and electronically embedding the document signature in the electronic document.

Some other embodiments are directed to electronically sign a document by a user by using an electronic device. The method includes displaying the document on a user interface of the electronic device, wherein the user interface includes one or more control fields for receiving one or more user inputs; capturing the one or more user inputs upon selection of the one or more control fields by the user, wherein the one or more user inputs include at one of a name text, a freehand signature, and a photograph of the user; processing the one or more user inputs to generate one or more outputs, wherein the processing is performed based on one or more predefined parameters associated with each of the one or more user inputs; storing the one or more outputs in a database on the electronic device, wherein the one or more outputs replace previously stored one or more outputs in the database; generating a document signature by using at least the one or more outputs, wherein the document signature is a unique one time signature identifying the user; and electronically embedding the document signature in the electronic document.

Yet other embodiments are directed to a system for electronically signing a document by a user by using an electronic device. The system includes displaying the document on a user interface of the electronic device, wherein the user interface includes one or more control fields for receiving one or more user inputs. The system also includes capturing the one or more user inputs upon selection of the one or more control fields by the user. The system also includes processing the one or more user inputs to generate one or more outputs, wherein the processing is performed based on one or more predefined parameters associated with each of the one or more user inputs. The system also includes generating a document signature by using at least the one or more outputs, wherein the document signature is a unique one time signature identifying the user. The system also includes electronically embedding the document signature in the electronic document.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a diagram of an electronic device in accordance with the disclosed subject matter.

FIG. 2 illustrates an exemplary authentication platform disposed in the electronic device in accordance with the disclosed subject matter.

FIG. 3 is a flowchart of a procedure for authenticating an electronic document in accordance with the disclosed subject matter.

FIG. 4A-4B are exemplary flowcharts of another procedure for authenticating an electronic document in accordance with the disclosed subject matter.

FIGS. 5A-5E are exemplary user interfaces of the electronic device illustrating addition of a freehand signature in an electronic document in accordance with the disclosed subject matter.

FIGS. 6A-6C are exemplary user interfaces of the electronic device illustrating addition of a name text in an electronic document in accordance with the disclosed subject matter.

FIGS. 7A-7B are exemplary user interfaces of the electronic device illustrating addition of a facestamp in an electronic document in accordance with the disclosed subject matter.

FIG. 8 is an exemplary view of an electronically signed document in accordance with the disclosed subject matter.

FIG. 9 illustrates an exemplary mobile system in accordance with the disclosed subject matter.

FIG. 10 is a diagram of an exemplary chip in accordance with the disclosed subject matter.

FIG. 11 is a diagram of an exemplary mobile device in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. Electronic Device Structure

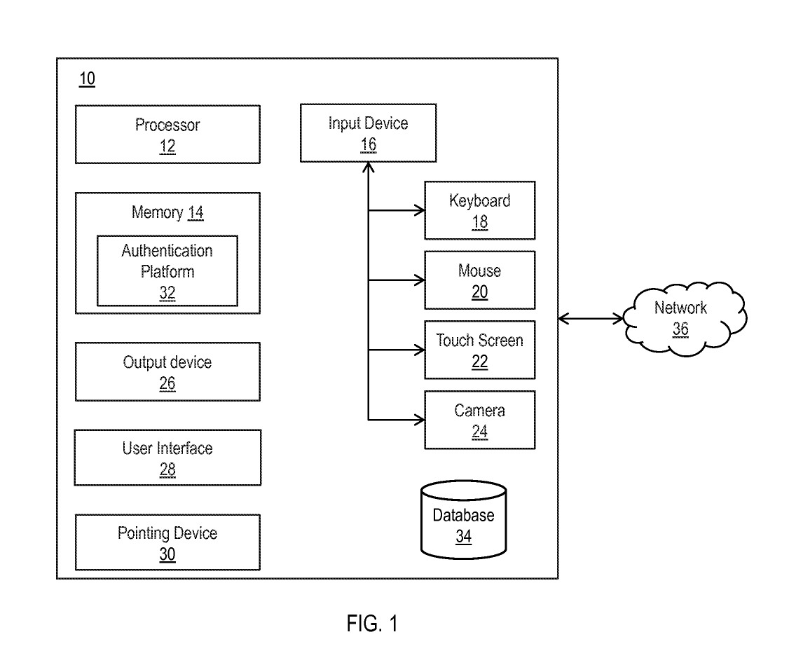

FIG. 1 is a diagram of an electronic device 10 that can include a processor 12, a memory 14, an input device 16, an output device 26, etc. Examples of the electronic device 10 include, but not restricted to, a laptop, a mobile device, a smartphone, a personal digital assistant (PDA), etc. In fact, embodiments are intended to include or otherwise cover any type of electronic device, including known, related art, and/or later developed technologies. In some embodiments, the electronic device 10 can include a number of applications, such as, but not restricted to, camera/imaging applications, media player applications, social networking applications, calendar applications, location-based service applications, etc. In certain embodiments, the electronic device 10 can also include a number of sensors (not shown) such as, but not restricted to, global positioning sensors for use in navigation systems, accelerometers for detecting orientation of the electronic device 10, biometric sensors for detecting biometrics of users, etc. Embodiments are intended to include or otherwise cover any type of sensors, including known, related art, and/or later developed technologies to enhance capabilities of the electronic device 10.

FIG. 1 illustrates the electronic device 10 as a mobile device, and embodiments are intended to include or otherwise cover any type of electronic device, including a smartphone, a tablet, etc. In fact, embodiments are intended to include or otherwise cover configurations of the electronic device 10.

In some embodiments, the processor 12 of the electronic device 10 can be a single core processor 12. In alternate embodiments, the processor 12 can be a multi-core processor 12. Embodiments are intended to include or otherwise cover any type of processor, including known, related art, and/or later developed technologies to enhance capabilities of processing data and/or instructions. The processor 12 can be used to process instructions stored in the memory 14.

Further, the electronic device 10 can include the memory 14. The memory 14 can be used to store instructions that can be processed by the processor 12. In some embodiments, the memory 14 can be, but not restricted to, a random access memory (RAM), a read only memory (ROM), etc. Embodiments are intended to include or otherwise cover any type of memory, including known, related art, and/or later developed technologies to enhance capabilities of storing data and/or instructions. The memory 14 can also include an operating system (not shown) for the electronic device 10.

The electronic device 10 can include an input device 16 that can be configured to receive inputs from a user of the electronic device 10. The input device 16 can include, but not restricted to, a keyboard 18, a mouse 20, a touch screen 22, a camera 24, etc. The keyboard 18 can be used to receive user inputs. For example, the keyboard 18 can be used to receive text inputs for an electronic document. In some embodiments, the keyboard 18 can include devices and/or logic that can be used to operate the electronic device 10. In certain embodiments, the user inputs can be received by using a stylus that enables the user to provide inputs to the electronic device 10. In some embodiments, the electronic device 10 can include a mouse 20 that can be used to detect motion on a surface of the electronic device 10. Further, the electronic device 10 can include a touch screen 22 that can be used to receive user inputs by the touch of the user. For example, the user can touch the screen of the electronic device 10 to provide inputs such as, but not restricted to, a name, a date, contact details, etc. The electronic device 10 can also include a camera 24 to take digital pictures. In some embodiments, the camera 24 can take still images of the user. In alternate embodiments, the camera 24 can take moving images (e.g., a video) of the user. The input device 16 can also include other devices such as, universal serial bus (USB), a microphone, etc. Embodiments are intended to include or otherwise cover any type of input device, including known, related art, and/or later developed technologies to enhance capabilities of receiving user inputs. The electronic device 10 can include output device 26, such as speakers, printers, projectors, etc. Embodiments are intended to include or otherwise cover any type of output device, including known, related art, and/or later developed technologies.

The electronic device 10 can include a system bus (not shown) to connect components of the electronic device 10 as discussed in detail above. The system bus can include several types of bus structures including a memory bus, or a memory controller, a peripheral bus, or a local bus using any of a variety of bus architectures. A basic input/output system (BIOS) stored in the memory 14 such as read only memory (ROM), can provide a basic routine that helps to transfer information between the components within the electronic device 10, during start-up.

The electronic device 10 can also include a user interface 28. In some embodiments, the user interface 28 can be a graphical user interface 28 of the electronic device 10. Embodiments are intended to include or otherwise cover any type of user interface, including known, related art, and/or later developed technologies.

In some embodiments, the electronic device 10 can include a pointing device 30 such as a joystick, finger tracking, trackball, etc. to receive user inputs. Embodiments are intended to include or otherwise cover any type of pointing device, including known, related art, and/or later developed technologies.

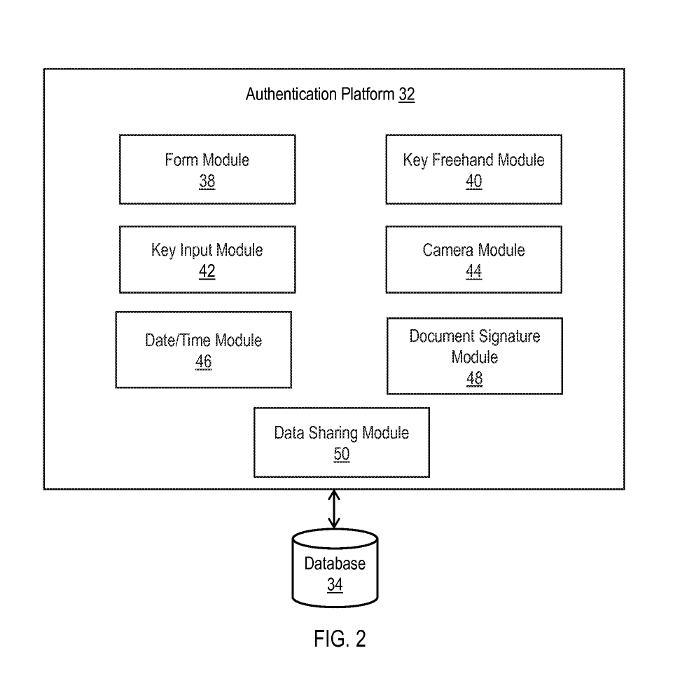

The memory 14 can include an authentication platform 32. The authentication platform 32 can be used to authenticate the electronic documents. In alternate embodiments, the authentication platform 32 can be an application stored in the memory 14 of the electronic device 10. The functioning of the authentication platform 32 is described in more detail below in conjunction with FIG. 2.

The electronic device 10 can also include a database 34 to store data such as images, contact details, etc. of the user of the electronic device 10. Embodiments are intended to include or otherwise cover any type of database, including known, related art, and/or later developed technologies to enhance capabilities of storing data and/or instructions.

The electronic device 10 can further communicate with other electronic devices through a communication network 36. In some embodiments, the communication network 36 can include a data network such as, but not restricted to, the Internet, local area network (LAN), wide area network (WAN), metropolitan area network (MAN), etc. In certain embodiments, the communication network 36 can include a wireless network, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc. Embodiments are intended to include or otherwise cover any type of communication network, including known, related art, and/or later developed technologies to communicate with other electronic devices.

### II. Functioning of the Authentication Platform

FIG. 2 illustrates the authentication platform 32 disposed in the electronic device 10, in accordance with the disclosed subject matter. In some embodiments, the authentication platform 32 can include, but not restricted to, a form module 38, a key freehand module 40, a key input module 42, a camera module 44, a date-time module 46, a document signature module 48, and a data sharing module 50.

In some embodiments, the form module 38 can be configured to receive details of the user of the electronic device 10. For example, the user details can include, but not restricted to, a name, a phone number, an email identification (ID), personal details, such as, a name of spouse, father's name, mother's name, etc. The form module 38 can further be configured to generate a profile of the user of the electronic device 10. In some embodiments, the form module 38 can generate the profile of the user by using the received user details. In certain embodiments, the form module 38 can update the user details periodically. The profile of the user can be stored in the database 34.

In some embodiments, the form module 38 can be configured to display a document or a form to the user. The document can be an electronic document that can be displayed on the user interface 28 of the electronic device 10. The document can be, for example, but not restricted to, an attendance register, a questionnaire, etc. In certain embodiments, the user can customize the document by adding customized control fields in the document. In some embodiments, the form module 38 can be configured to automatically fill the control fields of the document. For example, user details from the profile of the user can be used to automatically fill the document. In alternate embodiments, the form module 38 can be configured to enable the user to manually fill the control fields of the document.

In some embodiments, the form module 38 can also be configured to enable the user to create customized documents. In certain embodiments, the form module 38 can be configured to enable the user to adjust alignment of the documents. In alternate embodiments, the form module 38 can be configured to enable the user to re-arrange the order of control fields in the documents. In certain embodiments, the form module 38 can be configured to enable the user to add and/or delete header and footer from the documents. In some embodiments, the form module 38 can be configured to enable the user to add logo in the document. In some embodiments, the form module 38 can be configured to enable the user to store the document in the database 34.

The key freehand module 40 can be configured to receive freehand signature of the user. In some embodiments, the freehand signature can be received when the user selects a control field in the electronic document. The form module 38 can activate a section of the user interface to receive the freehand signature of the user. In certain embodiments, the touch screen 22 can be used to receive the freehand signature of the user. Embodiments are intended to include or otherwise cover any type of touch screen, including known, related art, and/or later developed technologies to receive the freehand signature of the user. In some embodiments, the key freehand module 40 can be configured to enable the user to change color of the freehand signature. For example, the user can change the color from a default ‘black’ color to ‘green’ color in the electronic document.

Further, the key freehand module 40 can be configured to process the freehand signature. In certain embodiments, the key freehand module 40 can be configured to convert the freehand signature of the user to a signature image. In some embodiments, the key freehand module 40 can be configured to resize dimensions of the signature image according to predefined parameters of a document signature area in the electronic document. The predefined parameters can include, but not restricted to, size, color, etc. associated with the freehand signature. In some embodiments, the key freehand module 40 can be configured to enable the user to store the freehand signature in the database 34. In alternate embodiments, the key freehand module 40 can be configured to enable the user to replace the previously stored freehand signature in the database 34

The key input module 42 can be configured to receive inputs from the user. The inputs can include, but not restricted to, a name text, an address text, etc. In certain embodiments, when the key input module 42 receives a selection of a control field in the electronic document by the user, then the key input module 42 can activate a keyboard section on the user interface 28 for receiving the user inputs, such as, a name text of the user. For example, when the user selects a control field on an electronic document, the key input module 42 can enable the user to input the name text by using the keyboard 18. Embodiments are intended to include or otherwise cover any type of keyboard, including known, related art, and/or later developed technologies to input the name text of the user. In alternate embodiments, the key input module 42 can be configured to receive other user inputs from the user.

Further, the key input module 42 can be configured to process the name text received from the user. In some embodiments, the key freehand module 40 can be configured to process the name text according to predefined conditions of a document signature area in the electronic document. The predefined parameters can include, but not restricted to, font, font size, color, etc. associated with the name text. In some embodiments, the key input module 42 can be configured to enable the user to store the name text in the database 34. In alternate embodiments, the key input module 42 can be configured to enable the user to replace the previously stored name text in the database 34.

The camera module 44 can be configured to activate the camera 24 of the electronic device 10 upon selection of a control field in the electronic document. The camera module 44 can be configured to capture a photograph of the user. In certain embodiments, the camera 24 can be a front camera 24 of the electronic device 10. In some embodiments, the camera module 44 can be configured to capture a photograph of the user whose freehand signature and the name text are received. In some embodiments, the photograph can be a facial photograph of the user.

Further, the camera module 44 can be configured to process the photograph of the user. In certain embodiments, the camera module 44 can be configured to resize the photograph of the user according to predefined parameters of a document signature area in the electronic document. The predefined conditions can include, but not restricted to, size, color, weight, etc. associated with the user input, such as, photograph of the user. In some embodiments, the camera module 44 can be configured to enable the user to store the photograph in the database 34. In alternate embodiments, the key freehand module 40 can be configured to enable the user to replace the previously stored photograph in the database 34.

The camera module 44 can also be configured to check operational status of the camera 24 of the electronic device 10. For example, the camera module 44 can check whether the camera 24 is open and can capture photograph of the user. In case, the camera module 44 determines that the camera 24 is closed or non-operational, then the camera module 44 can generate an error message. The camera module 44 can also be configured to display the error message on the user interface 28 of the electronic device 10, which indicates that the camera 24 is not working.

The date-time module 46 can be configured to capture date and time during which the freehand signature, the name text, and the photograph of the user are received. In some embodiments, the date-time module 46 can enable the user to select a format for the date and time. In certain embodiments, the date-time module 46 can enable the user to change date and time format in the electronic document.

The document signature module 48 can be configured to generate a document signature. The document signature module 48 can be configured to generate the document signature by using such as, but not restricted to, the name text, the freehand signature, the photograph, etc. of the user.

The document signature module 48 can further be configured to embed the generated document signature in the electronic document. In some embodiments, the document signature module 48 can embed the generated document signature in the document signature area within the electronic document. The document signature module 48 can also be configured to embed more than one document signature in the electronic document.

In some embodiments, the document signature module 48 can be configured to store the electronic document in the database 34. The document signature module 48 can be configured to store the electronic document in multiple formats, such as, but not restricted to, a word document, etc.

The data sharing module 50 can be configured to share the electronic document with other users. In some embodiments, the data sharing module 50 can be configured to share the electronic document through an email. In alternate embodiments, the data sharing module 50 can be configured to share the electronic document through cloud services. Embodiments are intended to include or otherwise cover any type of network services, including known, related art, and/or later developed technologies to share the electronic documents.

The above presented modules and components of the authentication platform 32 can be implemented in hardware, firmware, software, or a combination thereof. Though depicted as a separate entity in FIG. 2, it is contemplated that the authentication platform 32 can be implemented for direct operation by the electronic device 10.

### III. Operation of the Authentication Platform

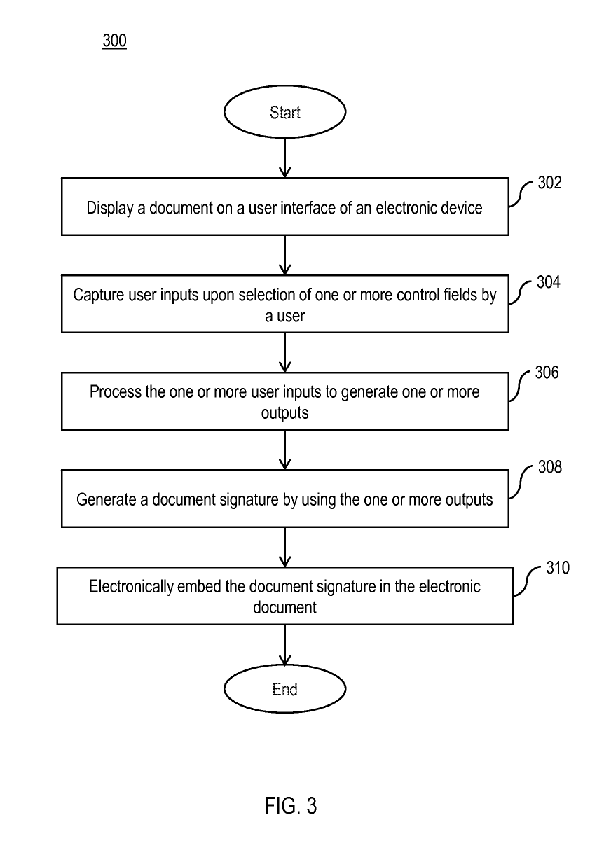

FIG. 3 is a flowchart of a procedure 300 for authenticating an electronic document in accordance with the disclosed subject matter. This flowchart is merely provided for exemplary purposes, and embodiments are intended to include or otherwise cover any methods or procedures for enabling a user to authenticate an electronic document.

In accordance with the flowchart of FIG. 3, the authentication platform 32 displays an electronic document on an electronic device 10 at step 102. The electronic device 10 can include, but not restricted to, a laptop, a mobile phone, a smartphone, etc. In some embodiments, the electronic document can include one or more control fields to receive user inputs.

At step 104, the authentication platform 32 captures the user inputs upon selection of the control fields by the user. The user inputs can include, but not restricted to, a name text, a freehand signature, a photograph, etc. associated with the user. In alternate embodiments, date and time are determined, at which the user inputs are captured.

At step 106, the authentication platform 32 processes the user inputs to generate one or more outputs. In exemplary embodiments, the user inputs are processed according to predefined parameters. The predefined parameters are associated with each of the user inputs. For example, a freehand signature can be processed according to, such as, but not restricted to, size, color, dimension, etc. associated with predefined signature area in the electronic document.

At step 108, the authentication platform 32 generates a document signature by using the one or more outputs such as processed signature image, name text, or a photograph. In some embodiments, the generated document signature is a unique one time signature that can be used to identify the user. The authentication platform 32 electronically embeds the generated document signature in the electronic document, at step 110. In certain embodiments, the electronic document including the embedded document signature can be displayed on the user interface 28 of the electronic device 10. In some embodiments, the electronic document including the embedded document signature can be stored in the database 34. In alternate embodiments, the electronic document including the embedded document signature can be stored in the memory 14 of the electronic device 10. In yet other embodiments, the electronic document including the embedded document signature can be shared with other electronic devices.

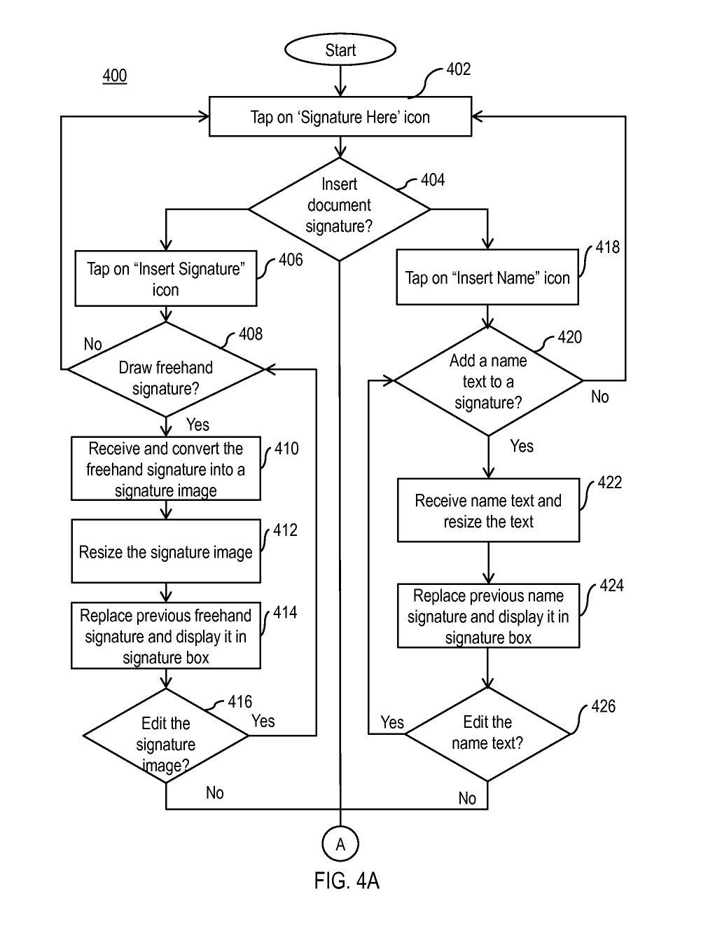

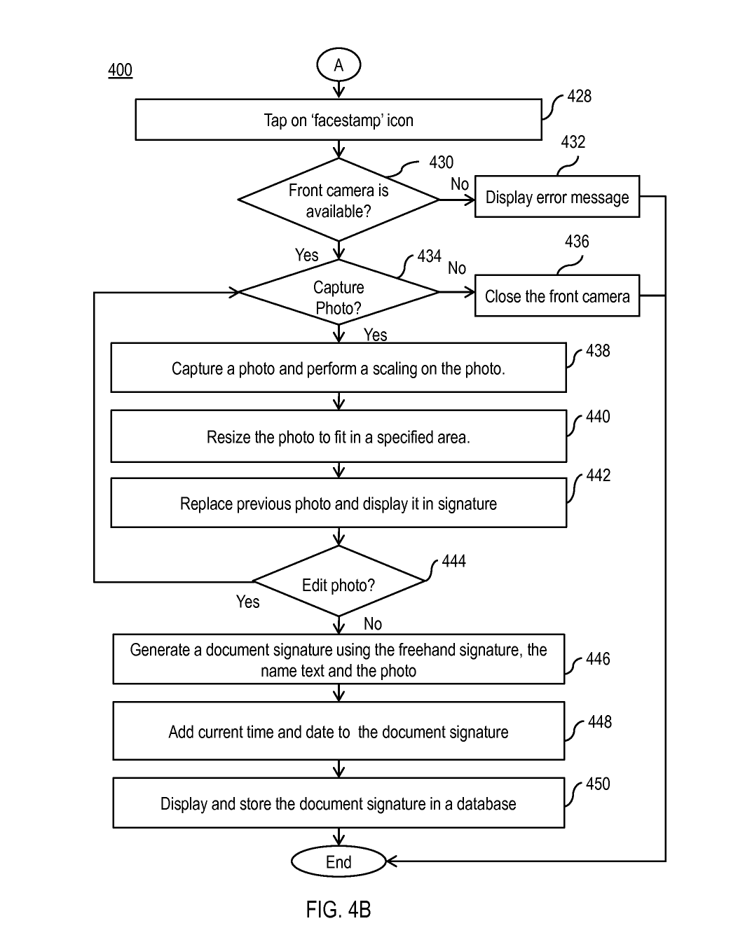

FIG. 4 is a flowchart of a procedure 400 for authenticating an electronic document in accordance with the disclosed subject matter. A user selects an electronic document and then taps on a ‘signature here’ icon, at step 402.

At step 404, the electronic device 10 determines whether to insert a document signature in the electronic document. The determination can be based on the inputs received from the user. In some embodiments, it is determined that which one from a signature a name text, or a photograph is to be included in the electronic document. If it is determined that the signature of the user is to be included in the document signature, then the procedure 400 proceeds to step 406. If it is determined that the name text of the user is to be included in the document signature, then the procedure 400 proceeds to step 418. If it is determined that the photograph of the user is to be included in the document signature, then the procedure 400 proceeds to step 428.

At step 406, the user taps on an ‘insert signature’ icon. The electronic device 10 determines whether the user desires to draw a freehand signature. If it is determined that the user desires to draw the freehand signature, then the procedure 400 proceeds to the 410 at which the freehand signature of the user is received. The freehand signature of the user is the processed to convert the freehand signature into a signature image.

Further, at step 412, the freehand signature of the user is processed to resize the signature image based on predefined parameters associated with the freehand signature. For example, size of the freehand signature is changed to a smaller dimension associated with a predefined document signature area in the electronic document. The resized freehand signature can be stored in a database, such as the database 34 and is displayed in a signature box of the electronic document, at step 414. In some embodiments, the resized freehand signature can replace the previously stored freehand signature in the database 34.

Next, at step 416, the electronic device 10 determines whether to edit the signature image in the electronic document. If it is determined that the user desires to edit the signature image, the procedure 400 returns to the step 408, otherwise the procedure 400 proceeds towards the step 418.

Further, at step 418, the user taps on an ‘insert name’ icon. The electronic device 10 determines whether the user desires to add a name in the electronic document, at step 420. If it is determined that the user desires to adds a name to the electronic document, the procedure 400 proceeds towards the step 422, otherwise, the procedure 400 returns towards the step 402.

At step 422, the electronic device 10 receives a name text from the user and resizes the name text based on the predefined parameters associated with the name text. For example, font and font size of the name text is changed according to predefined parameters associated with a predefined document signature area in the electronic document. The resized name text can be stored in a database 34, such as the database 34 and is displayed in a signature box of the electronic document, at step 424. In some embodiments, the resized name text can replace the previously stored name text in the database 34.

Next, at step 426, the electronic device 10 determines whether to edit the name text in the electronic document. If it is determined that the user desires to edit the name text, the procedure 400 returns to the step 420. In some embodiments, the electronic device 10 determines whether the user desires to add another name text to the electronic document. In case, the user desires to add a new name text in the electronic document, the procedure returns to the step 420. Otherwise, the procedure 400 proceeds towards the step 428.

Further, at step 428, the user taps on a ‘facestamp’ icon. The electronic device 10 then determines whether a front camera of the electronic device 10 is available, at step 430. If it is determined that the front camera of the electronic device 10 is available, the procedure 400 proceeds towards a step 434, otherwise, the procedure 400 proceeds towards step 432 and displays an error message.

In case, the front camera of the electronic device 10 is available, then the electronic device 10 determines whether the user desires to add a photo to the electronic document, at step 434. If it is determined that the user desires to add a photo to the electronic document, the electronic device 10 opens a lens of the camera 24 and the procedure 400 proceeds towards step 438, otherwise the electronic device 10 closes the front camera at step 436.

At step 438, the camera 24 of the electronic device 10 captures a facial photo of the user and performs scaling on the photo. The photo of the user is further processed to resize the photo based on the predefined parameters in order to fit the photo in a specified area of the electronic document, at step 440. The resized photo of the user can be stored in a database, such as the database 34 and is displayed in a signature box of the electronic document, at step 442. In some embodiments, the resized photo of the user can replace the previously stored photo in the database 34.

Next, at step 444, the electronic device 10 determines whether to edit the photo in the electronic document. If it is determined that the user desires to edit the photo, the procedure 400 returns to the step 434. In some embodiments, the electronic device 10 determines whether the user desires to add photo of another user to the electronic document. In case, the user desires to add a photo in the electronic document, the procedure returns to the step 434. Otherwise, the procedure 400 proceeds towards the step 446

At step 446, the electronic device 10 generates a document signature by using the freehand signature image, the name text and the photo. In addition, time and date at which the generated document signature was generated is added to the electronic document, at step 448.

Further, the generated document signature along with the current date and time is displayed in the user interface 28 of the electronic device 10 and is stored in a database, such as the database 34, at step 250.

### IV. Exemplary Embodiments

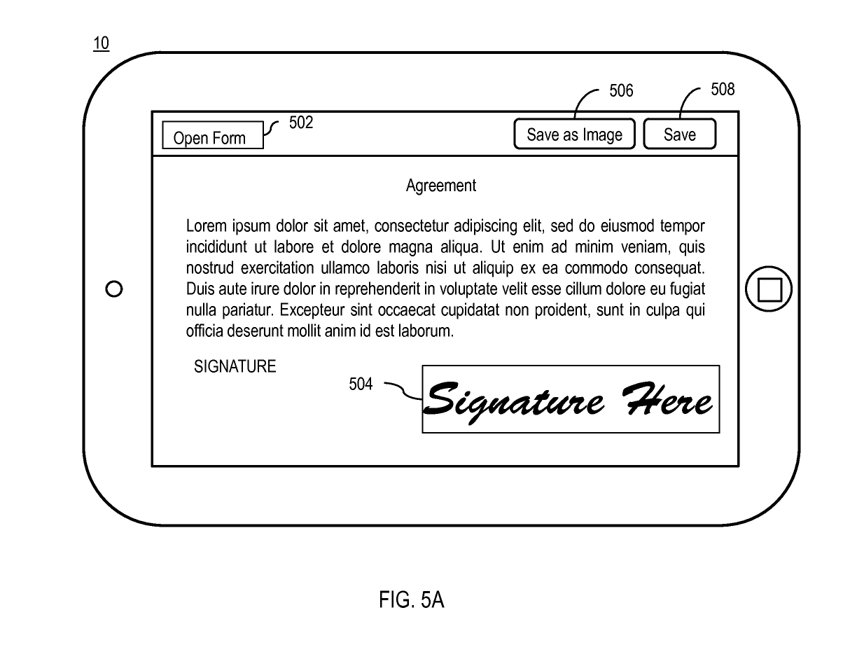

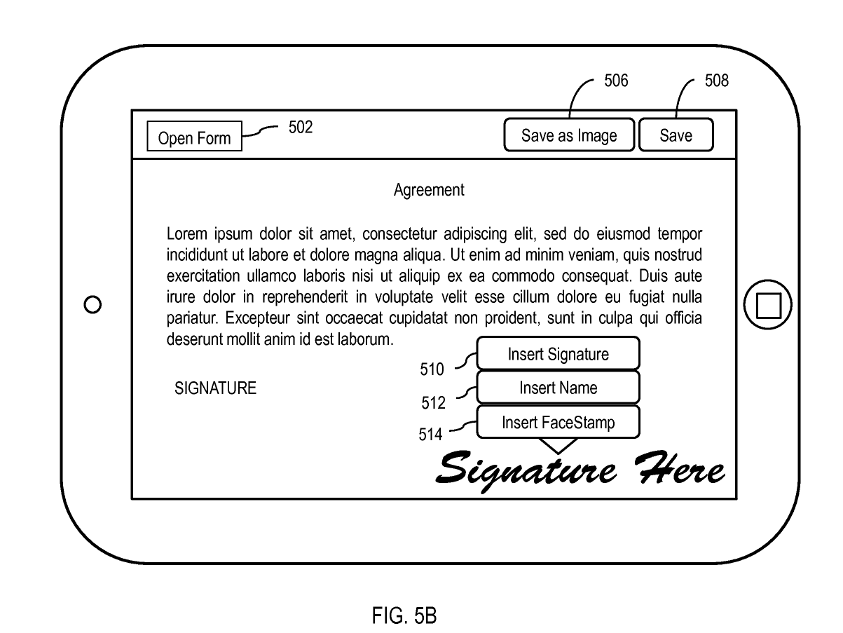

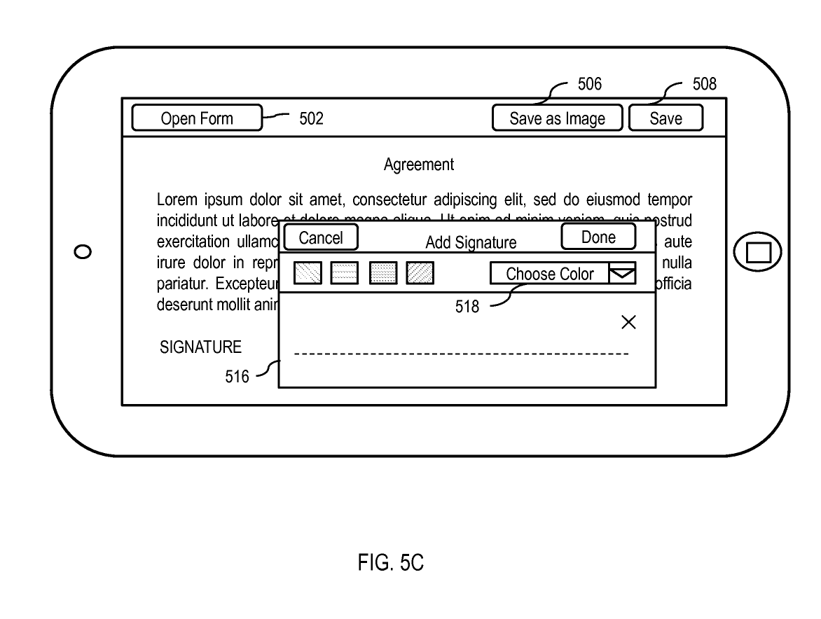

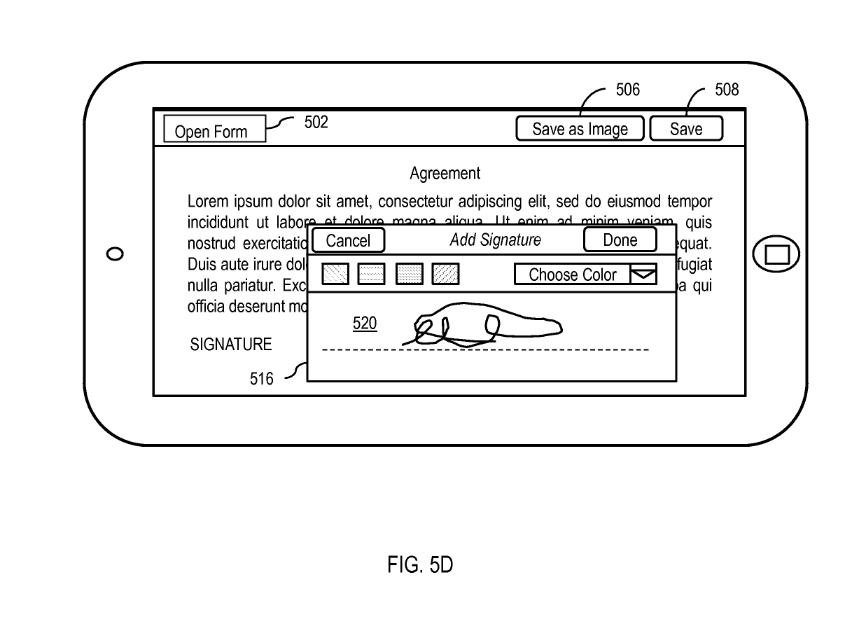

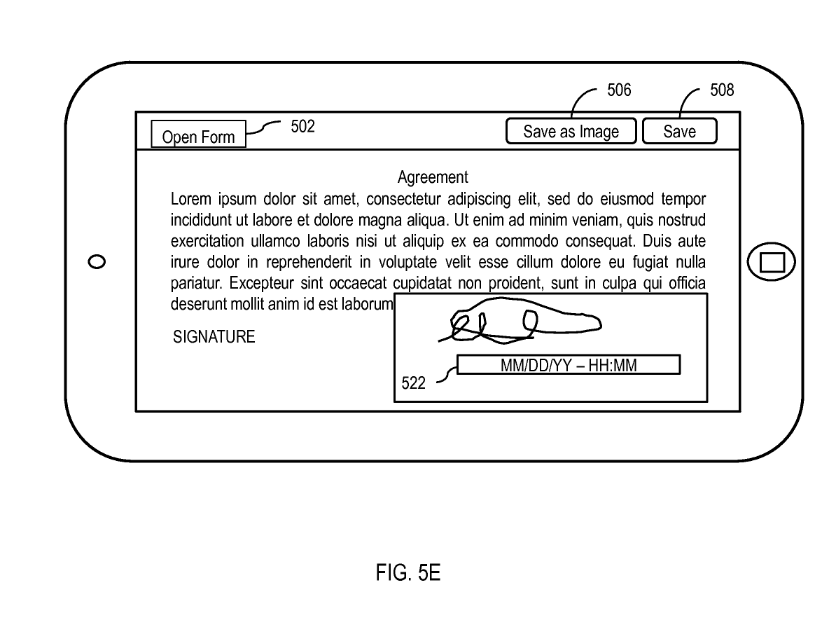

FIGS. 5A-5E are exemplary user interfaces illustrating addition of a freehand signature in an electronic document in accordance with the disclosed subject matter. In FIG. 5A, the electronic device 10 displays a form 502 in the user interface 28, which is an agreement between two parties. Therefore, there is a need to authenticate the form 502. A user of the electronic device 10 desires to electronically sign the form 502 in the electronic device 10. The user, therefore, taps on a ‘signature here’ icon 504. The user interface 28 of the electronic device 10 also displays other icons such as, but not restricted to, ‘save as image’ icon 506 and ‘save’ icon 508.

In FIG. 5B, when the user taps on the ‘signature here’ icon 504, the user interface 28 pops up further options for the user. As seen in FIG. 5B, an ‘insert signature’ icon 510, an ‘insert name’ icon 512 and an ‘insert facestamp’ icon 514 are displayed. When the user taps on the ‘insert signature’ icon 510, a window pops up to receive freehand signature of the user, as shown in FIG. 5C. In addition, the user can change the color of the freehand signature by selecting a ‘choose color’ icon 518.

In FIG. 5D, the user draws freehand signature 520 on a, but not restricted to, a touch screen user interface 28 of the electronic device 10. The freehand signature 520 of the user is processed based on the predefined parameters associated with the freehand signature and is converted to a signature image. The signature image is then displayed on the user interface 28 of the electronic device 10 and is stored in a database, such as the database 34 or the memory 14 of the electronic device 10. Further, a date and time 522 are added to the signature image at which the user electronically signed the form, as shown in FIG. 5E.

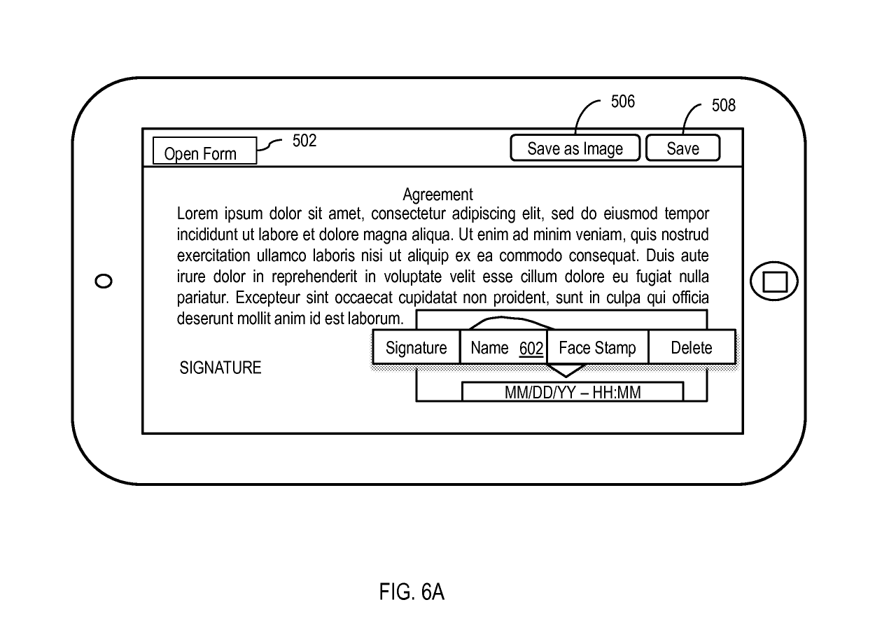

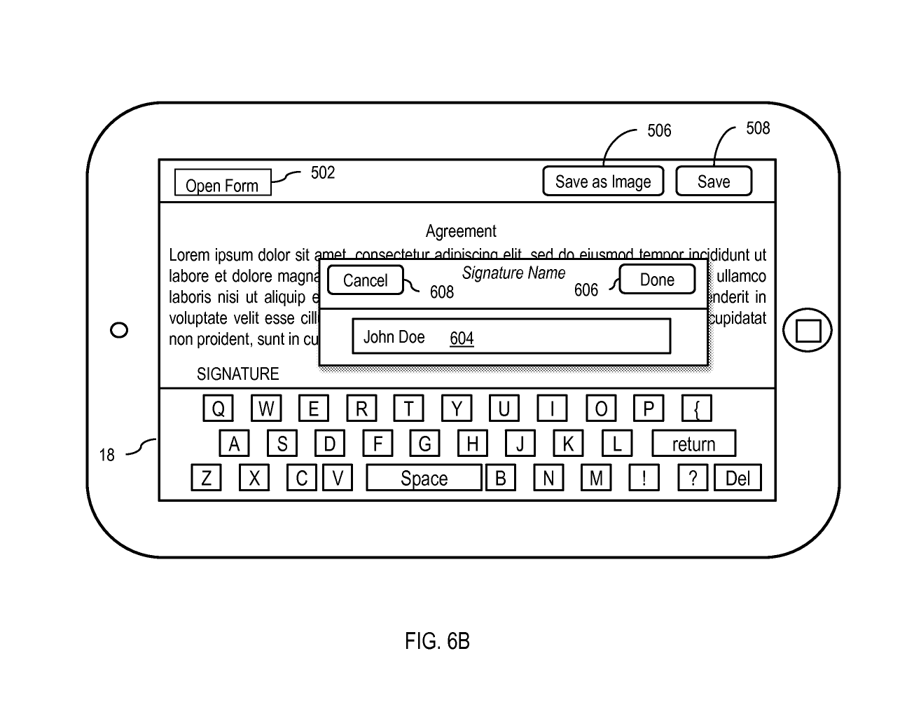

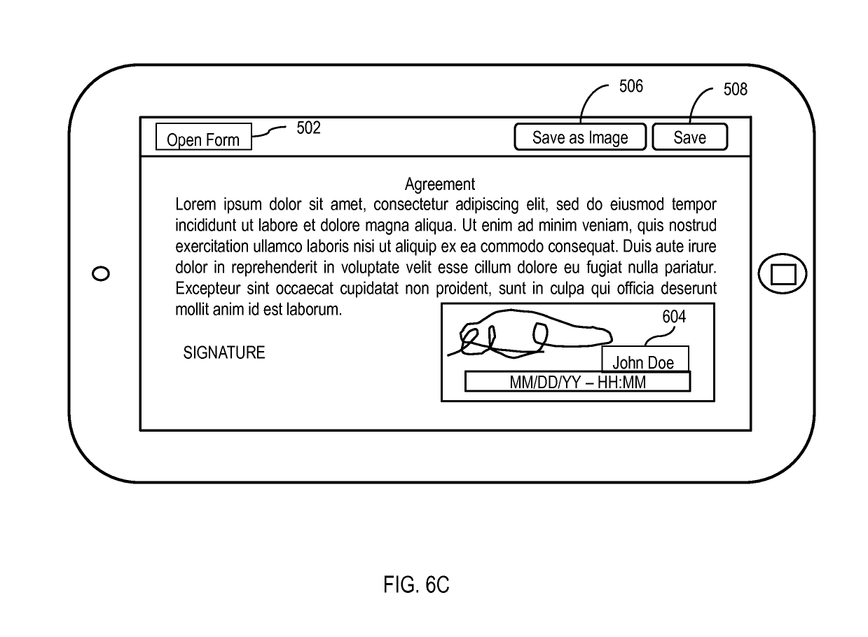

FIGS. 6A-6C are exemplary user interfaces illustrating addition of a name text in an electronic document in accordance with the disclosed subject matter.

In accordance with the FIG. 6A, the electronic device 10 displays the form 502 in the user interface 28, which is an agreement between two parties. The user of the electronic device 10 desires to add a name text in the form 502. The user therefore, taps on a ‘name’ icon 602. The user interface 28 of the electronic device 10 also displays other icons such as, but not restricted to, ‘signature’ icon, ‘facestamp’ icon, ‘delete’ icon, etc. The user can add the name text into the signature. In some embodiments, the user can add the name text by using the keyboard 18 of the electronic device 10. The user manually types the name ‘John Doe’ 604 by using the keyboard 18. The name ‘John Doe’ 604 is displayed on the user interface 28 of the electronic device 10. The user can then click on ‘Done’ icon 606 after adding the name text to the form 502. In some embodiments, the user can click on ‘Cancel’ icon 608 if do not desire to add the name to the form 502, as shown in FIG. 6B.

The name ‘John Doe’ 604 can then be processed and displayed on the user interface 28 of the electronic document, as shown in FIG. 6C.

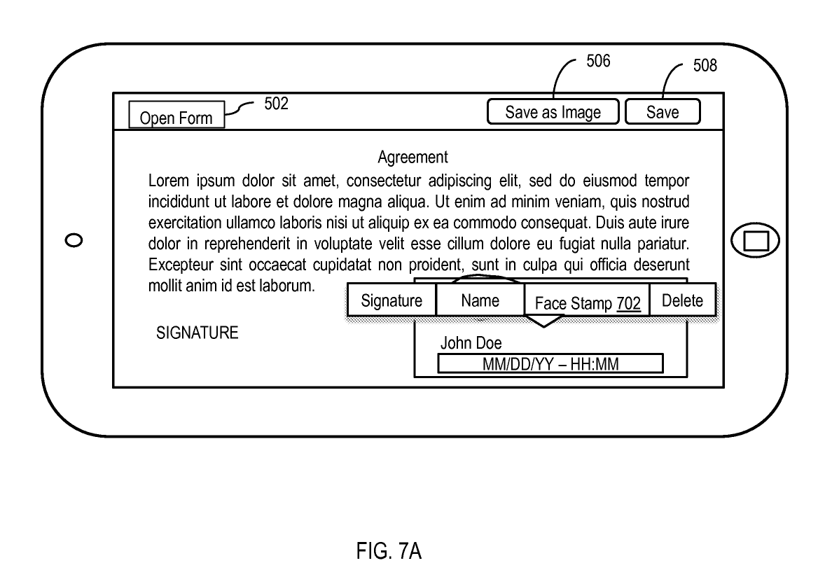

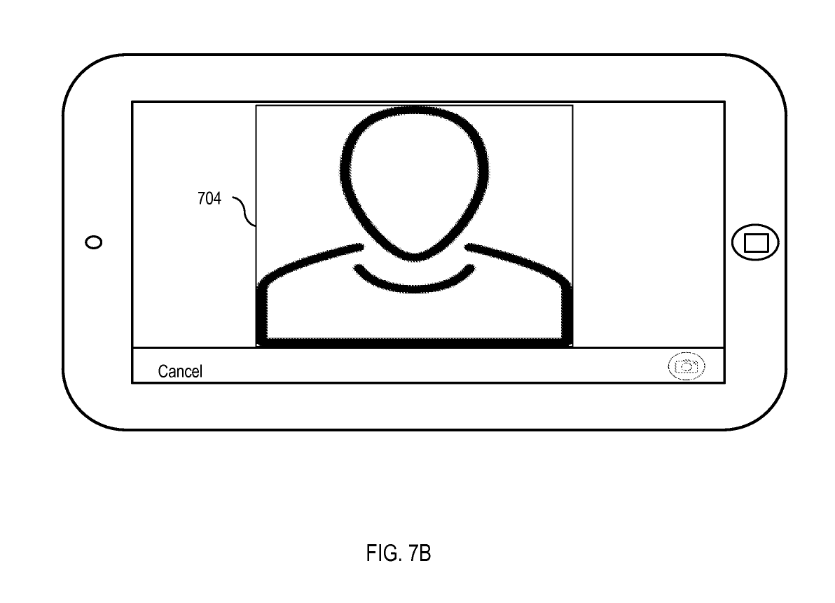

FIGS. 7A-7B are exemplary user interfaces illustrating addition of a facestamp in an electronic document in accordance with the disclosed subject matter.

As shown in FIG. 7A, the user desires to add a facestamp to the electronic document. Then the user clicks on a ‘facestamp’ icon 702. As soon as the user clicks on the ‘facestamp’ icon 702, the camera 24 of the electronic device 10 opens to capture a photograph 704 of the user. In alternate embodiments, if the camera 24 is non-operational, an error message is displayed on the user interface 28 of the electronic device 10. The camera 24 captures the photograph 704 of the user, as shown in FIG. 7B. The captured photograph 704 of the user is displayed on the form 502 and is stored in a database, such as the database 34 or the memory 14 of the electronic device 10. The captured photograph 704 of the user is then added to the signature of the user in the electronic document.

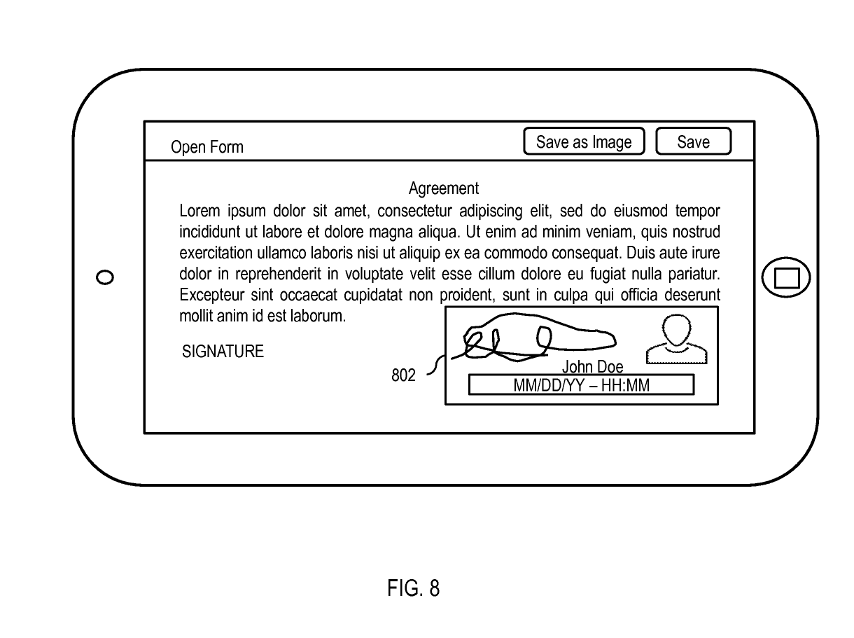

FIG. 8 is an exemplary view of an electronically signed document in accordance with the disclosed subject matter. The electronic signature 802 of the user includes the signature image, the name text, and the photograph of the user. The addition of the electronic signature 802 of the user in the electronic document increases the authenticity of the electronic document.

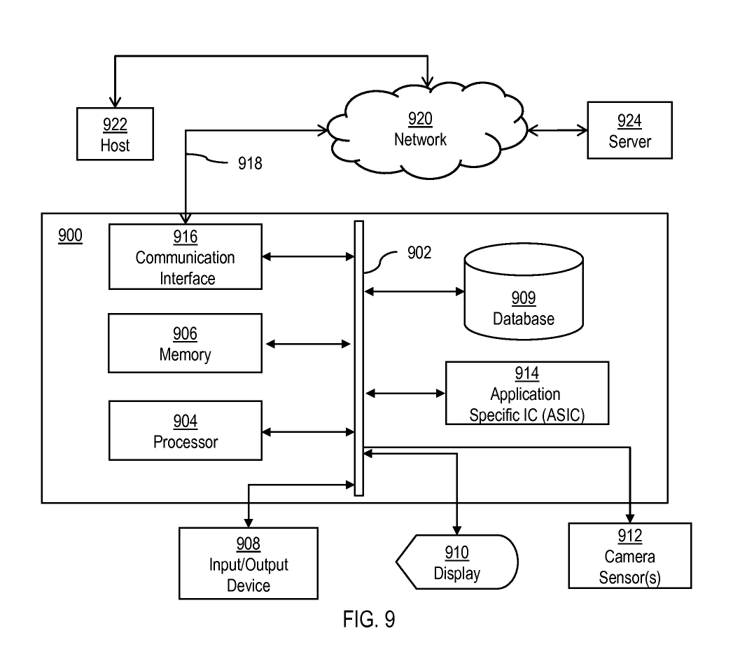

FIG. 9 illustrates an exemplary mobile system 900 upon which some embodiment of the disclosed subject matter can be implemented. In fact, embodiments of the disclosed subject matter are intended to include or otherwise cover any type of electronic device, including known, related art, and/or later developed technologies. The mobile system 900 can be programmed, for example, via computer program code or instructions to authenticate electronic documents described in the disclosed subject matter. The mobile system 900 can include a communication mechanism such as a bus 902 to pass data between internal and external components of the mobile system 900. The data can be represented as a physical expression of a measurable phenomenon, typically electric voltages, but can include, in some certain embodiments, such phenomena as magnetic, electromagnetic, pressure, chemical, biological, molecular, atomic, sub-atomic and quantum interactions. The mobile system 900, or a portion thereof, constitutes a means for performing one or more steps for authenticating electronic documents.

The bus 902 can include one or more parallel conductors of data so that the data can be transferred quickly among communication devices coupled to the bus 902. In some embodiments, a processor 904 is coupled with the bus 902 for processing the data. However, one processor 904 shown in FIG. 9 is for illustration purpose. However, in some alternate embodiments of the disclosed subject matter can include more than one processor 904.

The processor 904 can performs a set of instructions on the data as specified by computer program code related to authenticate the electronic documents. In some embodiments, the processor 904 can be implemented as mechanical, electrical, magnetic, optical, chemical, or quantum components, among others, alone or in combination.

The mobile system 900 can also include a memory 906. In certain embodiments, the memory 906 can be coupled to the bus 902. In some embodiments, the memory 906 can be, but not restricted to, a Random Access Memory (RAM), a Read only Memory (ROM) or any other dynamic or static storage device, stores information including processor instructions for storing data and instructions to be executed by the processor 904. In some embodiments, the memory 604 can include a volatile storage that can lose the data and instructions stored thereon when power is lost. In alternate embodiments, the memory 904 can include a non-volatile (persistent) storage device, such as a magnetic disk, a solid state disk, optical disk or flash card, for storing data, including instructions, that persists even when the mobile system 900 is turned off or otherwise loses power.

The mobile system 900 can include an external input device 908, such as a keyboard including alphanumeric keys operated by a human user, a microphone, a mouse, a joystick, a game pad, a stylus pen, a touch screen, a sensor, etc. for providing the data to the bus 902. In some embodiments, external devices can be coupled to the bus 902, can be used primarily for interacting with humans, can include a display 910. In certain embodiments, the display 910 can be, but not restricted to, a Cathode Ray Tube (CRT), a Liquid Crystal Display (LCD), a Light Emitting Diode (LED) display, an organic LED (OLED) display, active matrix display, Electrophoretic Display (EPD), a plasma screen, etc. In some embodiments, the mobile system 900 can include a camera sensor 912 to capture, record and cause to store videos, movies, etc., which can include audio recordings. However, one camera sensor 912 is shown in FIG. 9 for illustration purpose. However, in some alternate embodiments of the disclosed subject matter can include more than one camera sensor 912. Further, in some embodiments, the display 910 can be a touch-enabled display such as capacitive or resistive screen.

In some embodiments, special purpose hardware, such as an ASIC 914 can be coupled to the bus 902. The ASIC 914 can be configured to perform operations that cannot be performed by the processor 904 quickly enough for special purposes.

The mobile system 900 can also include a communication interface 916 coupled to the bus 902. The communication interface 916 can provide a one-way or two-way communication coupling to a variety of external devices, such as, but not restricted to, printers, scanners, external disks, etc. In some embodiments, the communication interface 916 can be a parallel port. In alternate embodiments, the communication interface 916 can be a serial port. Embodiments are intended to include or otherwise cover any type of communication interface, including known, related art, and/or later developed technologies. However, some alternate embodiments of the disclosed subject matter can employ more than one communication interface 916.

A network link 918 can provide communication data by using transmission media through one or more networks to other electronic devices that can use or process the data. In some embodiments, the network link 918 can be used to connect a network 920 to a host 922. In some embodiments, the host 922 connected to the network 920 can provide a service in response to the data received over the network 920. For example, a server 924 can host a process that can provide data representing a video for presentation at the display 910.

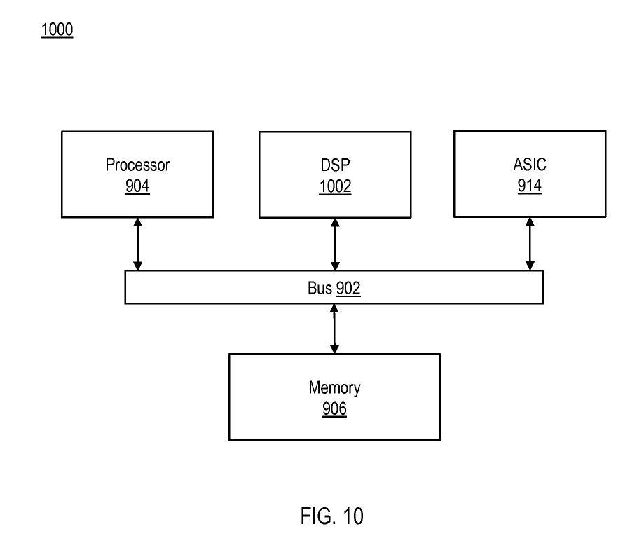

FIG. 10 is a diagram of a chip 1000 that can be used to implement embodiments of the disclosed subject matter. The chip 1000 can be programmed to process and transmit data in an efficient manner to reduce usage of bandwidth. The chip 1000 can be disposed as a physical package that can include one or more components such as, but not restricted to, electrical wires, the processor 904, the memory 906, etc. to provide one or more characteristics such as physical strength, conservation of size, and/or limitation of electrical interaction. In some embodiments, the components can be disposed in a single integrated chip. In alternate embodiments, the chip 1000 can be implemented as a single “system on a chip”.

The chip 1000, or a portion thereof, constitutes a means for performing one or more steps for authenticating electronic documents. In certain embodiments, the chip 1000 can include the bus 902 for passing the data among the components of the chip 1000. As discussed in detail above, the processor 904 has connectivity to the bus 902 to execute instructions and process data stored in, for example, the memory 906. In some embodiments, the processor 904 can be a single core processor. In alternate embodiments, the processor can be a multi-core processor that can enable multiprocessing within a single physical package.

The processor 904 can also be complemented with one or more specialized components to perform processing functions such as one or more Digital Signal Processors (DSP) 1026, or the one or more ASIC 914.

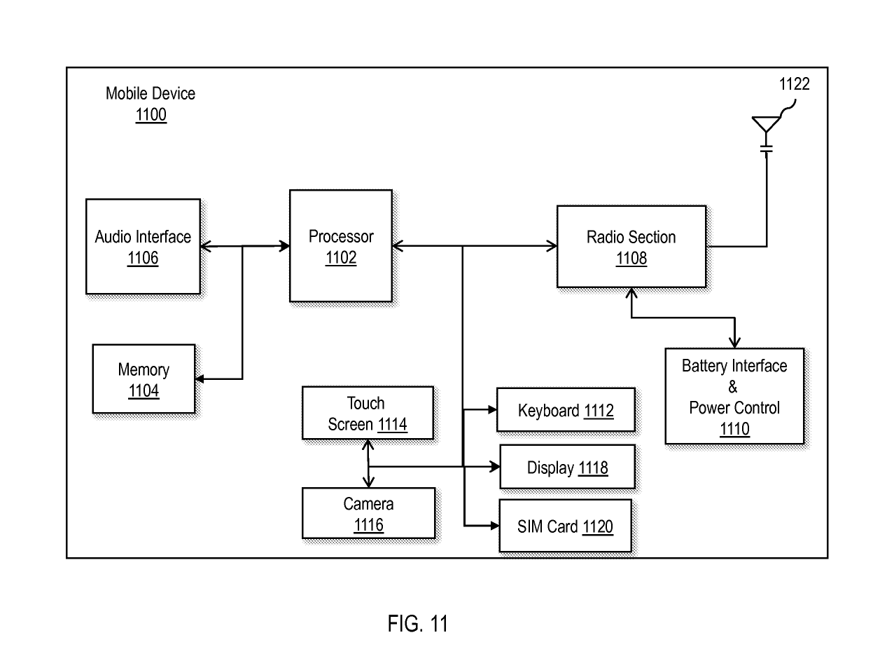

FIG. 11 is a diagram of an exemplary mobile device 1100 (e.g., a smartphone), which is capable of operating in the system of FIG. 1, in accordance with some of the embodiments of the disclosed subject matter. In some embodiments, the mobile device 1100, or a portion thereof, constitutes a means for authenticating electronic documents.

Some embodiments of the mobile device 1100 can include a processor 1102, a memory 1104, an audio interface 1106, etc. The audio interface 1106 can include a microphone and a microphone amplifier that can amplify speech signal output from the microphone.

In some embodiments, the mobile device 1100 can include a radio section 1108 that can amplify power and can convert frequency in order to communicate with a base station via an antenna 1122. The radio section 1108 can also be coupled to a battery interface and a power control unit 1110.

In some embodiments, the processor 1102 can receive various user inputs from such as, but not restricted to, a keyboard 1112, a touch screen 1114, a camera 1116, etc. Further, the processor 1102 also delivers a display command to a display 1118. The display 1118 can provide a display to a user in support of various applications that can perform or support the steps for authenticating electronic documents. The display 1118 can include a display circuitry (not shown) that can be configured to display a portion of a user interface of the mobile device 1100. The camera 1116 can be used to capture, record and cause to store videos, movies, etc., which can include audio recordings. However, the camera 1116 is shown in FIG. 11 for illustration purpose. However, in some alternate embodiments of the disclosed subject matter can include more than one camera 1116.

In some embodiments, the mobile device 1100 can also include a SIM card 1120. The SIM card 1120 can carry, such as, but not restricted to, important data, for example, cellular phone numbers, carrier supplying services, subscription details, security data, etc. The SIM card 1120 can serve primarily to identify the mobile device 1100 on a network, such as a radio network. In certain embodiments, the SIM card 1120 can include a memory for storing a personal telephone number registry, text messages, and user specific mobile terminal settings.

### V. Alternative Embodiments

While certain embodiments of the invention are described above, and FIGS. 1-11 disclose the best mode for practicing the various inventive aspects, it should be understood that the invention can be embodied and configured in many different ways without departing from the spirit and scope of the invention.

For example, embodiments are disclosed above in the context of an electronic device. However, embodiments are intended to include or otherwise cover any type of electronic device, including a smartphone, a tablet, etc. In fact, embodiments are intended to include or otherwise cover configurations of the electronic device.

Embodiments are disclosed above in the context of authenticating electronic documents. However, embodiments are intended to cover methods and apparatus for adding security to the electronic documents.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations of airbag housing assemblies disclosed above.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for electronically signing a document by a user by using an electronic device, the method comprising:
displaying the document on a user interface of the electronic device, wherein the user interface includes one or more control fields for receiving one or more user inputs;
capturing the one or more user inputs upon selection of the one or more control fields by the user;
processing the one or more user inputs to generate one or more outputs, wherein the processing is performed based on one or more predefined parameters associated with each of the one or more user inputs;
generating a document signature by using at least one of the one or more outputs, wherein the document signature is a unique one time signature identifying the user; and
electronically embedding the document signature in the electronic document.

2. The method of claim 1, wherein the one or more user inputs include at one of a name text, a freehand signature, and a photograph of the user.

3. The method of claim 1, further comprising
activating a camera of the electronic device on selection of a control field by the user, wherein the camera captures at least one photograph of the user.
checking an operational status of a camera of the electronic device; and
displaying an error message on the user interface when the camera is non-operational, wherein the camera is a front camera of the electronic device for capturing facial photograph of the user.

4. The method of claim 1, further comprising, on selection of a control field by the user, activating at least a section of the user interface for receiving a freehand signature of the user, wherein the user interface is displayed on a touch screen of the electronic device.

5. The method of claim 1 further comprising, on selection of a control field by the user, activating a keyboard section on the user interface for receiving a name text of the user, wherein the user interface is displayed on a touch screen of the electronic device.

6. The method of claim 1, wherein the document signature further includes at least a date and time of capturing the one or more user inputs.

7. The method of claim 1, wherein the processing the one or more user inputs includes:
converting a freehand signature to a signature image; and
resizing dimensions of the signature image to fit a predefined document signature area on the user interface.

8. The method of claim 1, wherein the processing the one or more user inputs includes resizing a photograph of the user to fit a predefined document signature area on the user interface.

9. The method of claim 1, wherein the processing the one or more user inputs includes resizing dimensions of a name text to fit a predefined document signature area on the user interface.

10. The method of claim 1, further comprising storing the one or more outputs in a database on the electronic device, wherein the one or more outputs replace previously stored one or more outputs in the database.

11. A method for electronically signing a document by a user by using an electronic device, the method comprising:
displaying the document on a user interface of the electronic device, wherein the user interface includes one or more control fields for receiving one or more user inputs;
capturing the one or more user inputs upon selection of the one or more control fields by the user, wherein the one or more user inputs include at one of a name text, a freehand signature, and a photograph of the user;
processing the one or more user inputs to generate one or more outputs, wherein the processing is performed based on one or more predefined parameters associated with each of the one or more user inputs;
storing the one or more outputs in a database on the electronic device, wherein the one or more outputs replace previously stored one or more outputs in the database;
generating a document signature by using at least one of the one or more outputs, wherein the document signature is a unique one time signature identifying the user; and
electronically embedding the document signature in the electronic document.

12. The method of claim 11, further comprising
activating a camera of the electronic device on selection of a control field by the user, wherein the camera captures at least one photograph of the user.
checking an operational status of a camera of the electronic device; and
displaying an error message on the user interface when the camera is non-operational, wherein the camera is a front camera of the electronic device for capturing facial photograph of the user.

13. The method of claim 11, further comprising, on selection of a control field by the user, activating at least a section of the user interface for receiving a freehand signature of the user, wherein the user interface is displayed on a touch screen of the electronic device.

14. The method of claim 11, further comprising, on selection of a control field by the user, activating a keyboard section on the user interface for receiving a name text of the user, wherein the user interface is displayed on a touch screen of the electronic device.

15. The method of claim 11, wherein the processing the one or more user inputs includes:
converting a freehand signature to a signature image; and
resizing dimensions of the signature image to fit a predefined document signature area on the user interface.

16. The method of claim 11, wherein the processing the one or more user inputs includes resizing a photograph of the user to fit a predefined document signature area on the user interface.

17. The method of claim 11, wherein the processing the one or more user inputs includes resizing dimensions of a name text to fit a predefined document signature area on the user interface.

18. A system for electronically signing a document by a user by using an electronic device, the system comprising:
a processor; and
a memory, coupled to the processor, wherein the memory comprising at least one instruction executable by the processor, wherein the at least one instruction comprising:
displaying the document on a user interface of the electronic device, wherein the user interface includes one or more control fields for receiving one or more user inputs;
capturing the one or more user inputs upon selection of the one or more control fields by the user;
processing the one or more user inputs to generate one or more outputs, wherein the processing is performed based on one or more predefined parameters associated with each of the one or more user inputs;
generating a document signature by using at least one of the one or more outputs, wherein the document signature is a unique one time signature identifying the user; and
electronically embedding the document signature in the electronic document.

19. The system of claim 18, further comprising
activating a camera of the electronic device on selection of a control field by the user, wherein the camera captures at least one photograph of the user.
checking an operational status of a camera of the electronic device; and
displaying an error message on the user interface when the camera is non-operational, wherein the camera is a front camera of the electronic device for capturing facial photograph of the user.

20. The system of claim 18, wherein the one or more user inputs include at one of a name text, a freehand signature, and a photograph of the user.
